(19) United States
(12) Patent Application Publication
(10) Pub. No.: US 2015/0027065 A1
(43) Pub. Date: Jan. 29, 2015

(54) DIAMOND COMPOSITE AND A METHOD OF MAKING A DIAMOND COMPOSITE

(71) Applicant: SANDVIK INTELLECTUAL PROPERTY AB, Sandviken (SE)

(72) Inventors: Andreas Blomqvist, Uppsala (SE); Susanne Norgren, Huddinge (SE); Malin Martensson, Nacka (SE); Ehsan Jalilian, Hagersten (SE); Thomas Easley, Columbus, OH (US)

(21) Appl. No.: 14/369,401

(22) PCT Filed: Dec. 19, 2012
(86) PCT No.: PCT/EP2012/076156

§ 371 Date: Jun. 27, 2014

Related U.S. Application Data
(60) Provisional application No. 61/581,662, filed on Dec. 30, 2011.

(51) Int. Cl. C04B 35/52; C04B 35/573; C04B 35/628; C04B 35/565

(52) U.S. Cl. CPC C04B 35/52; C04B 35/565; C04B 35/573; C04B 35/62834; C04B 35/62828; C04B 2235/427; C04B 2235/3826
USPC 51/307

(57) ABSTRACT

The present invention relates to a diamond composite comprising diamond particles embedded in a binder matrix comprising SiC and a Mₙ₊₁AXₙ-phase, where no diamond-to-diamond bonding are present. For the Mₙ₊₁AXₙ-phase n=1-3, M is one or more elements selected from the group Sc, Ti, Zr, Hf, V, Nb, Ta, Cr and Mo, A is one or more elements selected from the group Al, Si, P, S, Ga, Ge, As, Cd, In, Sn, Tl, and Pb and X is carbon and/or nitrogen.

The present invention relates to a diamond composite comprising diamond particles embedded in a binder matrix comprising SiC and a Mₙ₊₁AXₙ-phase. No diamond-to-diamond bonding is present in the composite.

### BACKGROUND

Cutting tools of diamond composites are known in the art. There are several different types of diamond composite materials. The most common is polycrystalline diamond (PCD), but in recent years the interest for thermally stable diamond materials, wherein the Silicon Carbide Diamond (SCD) material belongs, has increased.

PCD material comprises a matrix of diamond crystals comprising direct diamond to diamond bonding which is created under high pressure/high temperature (HP/HT) conditions with the help of a metallic catalyst such as Co, Ni, Fe and/or Mn or alloys thereof.

For SCD-materials, no diamond to diamond bonds are present. Instead, the diamond grains are embedded into a thermally stable ceramic binder matrix, e.g. SiC and the sintered material is essentially free of any catalyst metals such as Co, Ni, Fe and or Mn.

PCD and SCD tools have different properties and are therefore not always suitable for the same applications. A PCD-material has a higher abrasive resistance, toughness and strength at room temperature compared with SCD, but since a PCD material contains catalyst metals, e.g. Co, the degradation of diamonds into graphite will start at temperatures around 700° C. That means that PCD materials are less suitable for applications performed at high temperatures. Another disadvantage with PCD materials is that there is a large difference in thermal expansion between the metal(s) and the diamond. This problem is more pronounced if the catalyst metals are not evenly distributed in the PCD table, this can cause fractures during cutting/drilling/milling operations.

SCD materials have good thermal conductivity properties which is beneficial when used in high temperature applications. Furthermore, SiC does not catalyze the back conversion of the diamonds into graphite. The SCD material is thus thermally stable at temperatures well above 700° C. Since the hot hardness of the continuous ceramic binder matrix (SiC) is good, the SCD material has a high performance in drilling/cutting/milling operations also at higher temperatures. The difference in thermal expansion coefficient between diamond and silicon carbide is lower than the difference between diamond and a metallic phase like Co, but if too much residual Si is present and/or inhomogeneous distributed in the SCD-material, fractures can occur during operations.

U.S. Pat. No. 7,008,672 B2 describes how to make a SCD material comprising diamond grains embedded into a SiC matrix. The SCD material is manufactured by first making a porous body of the diamond grains. The porous body is then heat treated so that some of the diamond is transformed into graphite. The resulting body is then infiltrated with Si which reacts with the graphite to form the SiC binder matrix. One of the drawbacks of this method is that diamonds are used as a graphite source, which is quite expensive.

MAX-phases are known in the art as compounds of the formula Mₙ₊₁AXₙ with n=1-3. MAX-phases are layered, hexagonal carbides and nitrides where M is an early transitional metal, A is an A-group element usually selected from the groups 12, 13, 14 or 15 of the periodic table. X can be carbon and/or nitrogen.

WO 2010/128492 describes a PCD diamond composite comprising intergranular bonding between the diamond grains having a binder of MAX-phase. No SiC is present in the binder.

It is an object of the present invention to achieve a SCD diamond composite with an improved toughness while maintaining an adequate hardness.

It is an object of the present invention to minimize the amount of residual Si in the final product.

Yet another object of the present invention is to control the graphitization of diamonds.

### DRAWINGS

FIG. 1 shows an X-ray diffractogram of the composite made according to Example 1.

FIG. 2 shows an X-ray diffractogram of the composite made according to Example 2.

FIG. 3 shows an X-ray diffractogram of the composite made according to Example 3

### DETAILED DESCRIPTION OF THE INVENTION

The present invention relates to a diamond composite comprising diamond particles embedded in a binder matrix comprising SiC and a Mₙ₊₁AXₙ-phase, where no diamond-to-diamond bonding are present. For the Mₙ₊₁AXₙ-phase n=1-3, M is one or more elements selected from the group Sc, Ti, Zr, Hf, V, Nb, Ta, Cr and Mo, A is one or more elements selected from the group Al, Si, P, S, Ga, Ge, As, Cd, In, Sn, Tl, and Pb and X is carbon and/or nitrogen.

By the expression that no diamond-diamond bonding is present is herein meant that the diamond particles are not the continuous phase, i.e. the diamond particles are embedded in other phases.

The diamond composite is essentially free from Co, Fe, Ni or Mn. By essentially free is herein meant that no Co, Fe, Ni or Mn has been deliberately added, if present the amount is on the level of a technical impurity originating from the diamond manufacturing process. Manufacturing of diamonds sometimes include elements like Co, Fe, Ni and Mn which can be encapsulated into the diamond crystals. Impurity levels can be up to 5000 ppm, preferably less than 4000 ppm and more preferably less than 2000 ppm.

The diamond particles suitably have a grain size of between 1 to 500 μm, preferably 3 to 300 μm and more preferably 5 to 200 μm.

The diamond particles suitably constitute between 20 to 90 vol % of the total volume, preferably 30 to 90 vol % and more preferably 50 to 90 vol % of the sintered composite.

The SiC can contain small amounts of additional elements such as the elements M, A and X, as listed above for the Mₙ₊₁AXₙ-phase, and Boron. The amount of additional elements has to be kept at a level low enough so that the cubic structure of SiC is maintained. By cubic structure for SiC is herein meant Moissanite PDF-card 029-1129, but the unit cell dimension can vary if the Si or C sites are partly substituted by for example N and Ti.

The amount of SiC in the binder is suitably 1 to 55 vol % of the total volume, preferably 1 to 45 vol % and more preferably 1 to 35 vol % of the sintered composite.

The amount of Mₙ₊₁AXₙ-phase is suitably 1 to 50 vol % of the total volume, preferably 5 to 45 vol % and more preferably 5 to 35 vol % of the sintered composite.

In one embodiment the amount of Mₙ₊₁AXₙ-phase is 1 to 45 vol %, more preferably 2 to 35 vol %.

In one embodiment of the present invention, for the Mₙ₊₁AXₙ-phase, n=1, and A is preferably Si and/or Al, preferably the Mₙ₊₁AXₙ-phase is one of Cr₂AlC, V₂AlC, Ti₂AlN, Nb₂AlC, Ta₂AlC or Cr₂SiC.

In one embodiment of the present invention, for the Mₙ₊₁AXₙ-phase, n=2 and X is carbon, A is preferably Si and/or Al, preferably the Mₙ₊₁AXₙ-phase is one of Ti₃SiC₂, V₃AlC₂, Ti₃AlC₂, Ta₃AlC₂ or Ti₃(Al,Si)C₂.

In one embodiment of the present invention, for the Mₙ₊₁AXₙ-phase, n=3, A is preferably Si and/or Al, preferably the Mₙ₊₁AXₙ-phase is one of Ti₄AlN₃, V₄AlC₃, Ti₄SiC₃, Nb₄AlC₃ or Ta₄AlC₃.

The sintered compact can also comprise other phases in smaller amounts depending on the exact composition. In one embodiment, the sintered compact comprises 0 to 25 vol % of a TiₓSi_{y} phase e.g. TiSi₂, SiTi, Ti₃Si, Ti₅Si₄ or Ti₅Si₃. The present invention also relates to a method of making a diamond composite according to the above. The method comprises the steps of:
mixing the diamond particles with a Si source and powders comprising the Mₙ₊₁AXₙ-phase and/or the one or more element M and the one or more element A either as pure metals or as carbides, nitrides, carbonitrides or oxycarbonitrides, in a mixing liquid to form a slurry. The slurry is then dried into a powder. The powder is then subjected to a sintering operation to form a sintered body.

The present invention also relates to another method of making a diamond composite according to the above. The method comprises the steps of:
mixing the diamond particles with powders comprising the Mₙ₊₁AXₙ-phase and/or the one or more element M and the one or more element A either as pure metals or as carbides, nitride, carbonitrides or oxycarbonitrides, in a mixing liquid to form a slurry. The slurry is then dried into a powder which is then formed into a body of desired shape. The body is then subjected to infiltration of a Si source during the sintering operation.

The diamond particles suitably have a grain size of between 1 to 500 μm, preferably 3 to 300 μm and more preferably 5 to 200 μm. The amount of diamond particles that are to be added is estimated from the aimed value of vol % diamonds in the sintered material.

In one embodiment of the present invention the diamond particles can be coated.

In one embodiment of the present invention the coating material is a metallic coating of one or more elements selected from the group Si, V, Cr, Ti, Nb, Ta, Al, Hf and Zr.

In one embodiment of the present invention the coating material is carbides, nitrides or carbonitrides, or mixtures thereof, of one or more elements selected from the group Si, Cr, V, Ti, Nb, Ta, Al, Hf and Zr.

In one embodiment of the present invention, at least part of the one or more element M and/or the one or more element A either as pure metals or as carbides, nitrides, carbonitrides or oxycarbonitrides, is added as a coating on the diamonds as a measure to slow down the carbon diffusion from the diamonds to the binder.

In one embodiment of the present invention powders of Mₙ₊₁AXₙ-phase is added. The amount of powders of Mₙ₊₁AXₙ-phase that are to be added is estimated from the aimed value of vol % Mₙ₊₁AXₙ-phase in the sintered material. Due to the large difference in molecular weight between the different elements constituting M and A, it is difficult to express that in weight. Therefore specific calculations of the added amount need to be done for each MAX-phase.

In one embodiment of the present invention powders forming the Mₙ₊₁AXₙ-phase is added as either pure metals, or as carbides, nitrides, carbonitrides or oxycarbonitrides of the M and A elements, where M is one or more elements selected from the group Sc, Ti, Zr, Hf, V, Nb, Ta, Cr and Mo and A is one or more elements selected from the group Al, Si, P, S, Ga, Ge, As, Cd, In, Sn, TI, and Pb. The Mₙ₊₁AXₙ-phase is then formed during the sintering step. The amount of powders forming the Mₙ₊₁AXₙ-phase that are to be added is estimated from the aimed value of vol % Mₙ₊₁AXₙ-phase in the sintered material. Due to the large difference in molecular weight between the different elements forming the elements M and A, it is difficult to express that in weight. Therefore specific calculations of the added amount need to be done for each Mₙ₊₁AXₙ-phase.

The Si-source is suitably one or more of elemental Si, Si₃N₄, SiC or Si-containing alloys, preferably Si. The Si-source can be added to the slurry as such, or, in the case where the diamond grains are coated with Si or SiC, at least part of the Si-source is added through the coating.

To form a slurry, a mixing liquid is required. The milling liquid is preferably water, alcohol or an organic solvent, more preferably water or a water and alcohol mixture and most preferably water.

Drying of the slurry is preferably done according to known techniques, in particular spray-drying (SD) or spray freeze drying (SFD).

In SD the slurry containing the powdered materials mixed with the liquid and possibly the organic binder is atomized through an appropriate nozzle in the drying tower where the small drops are instantaneously dried by a stream of hot gas, for instance in a stream of nitrogen, to form agglomerated granules. In SFD the slurry is atomized into liquid nitrogen and the granules are instantly frozen and must thereafter be freeze dried under vacuum. The most common liquid used in SFD is water. The formation of granules is necessary in particular for getting a homogenous distributed raw material, but also to ease the feeding of compacting tools used in the subsequent stage. If needed, dispersing agents, e.g. polyacrylate co-polymers, polyelectrolytes, salts of acrylic polymers and or a thickener agent for example cellulosic based can also be added to the slurry. Dispersing agents are added for monitoring the separation of the particles as well as the slurry properties and thus the properties of the resulting granulated powder.

For small scale experiments, other drying methods can also be used, like pan drying.

In one embodiment of the present invention a body is formed by pressing prior to the sintering step. Usually a pressing agent is added to the slurry prior to drying. The pressing agent can suitably be paraffin, polyethylene glycol (PEG), Polyvinyl alcohol (PVA), long chain fatty acids etc. The amount of pressing agent is suitably between 15 and 25 vol % based on the total dry powder weight, the amount of organic binder is not included in the total dry powder volume. The pressing can be done in any uniaxial or multiaxial pressing operation known in the art.

The pressing can also be done without the addition of a pressing agent, e.g. if the material is subjected to hot pressing.

Sometimes the pressing and sintering is done sequentially in a single operation. For both HP/HT process and for Spark Plasma Sintering (SPS) pressing and sintering occurs simultaneously.

The organic binders must be removed before the sintering and this can be performed in a fluid gas of air, nitrogen, hydrogen, argon or mixtures thereof at temperatures between 200 to 600° C., depending on the binder system. The resulting body must have enough green strength to hold together and by monitoring the de-binding conditions the residual amount of carbon and thus the strength of the body can be controlled.

The sintering operation can be performed with or without applied pressure, preferably with pressure. Examples of sintering operations without applied pressure are sintering in ambient pressure using inert gases or vacuum. Examples of sintering operations with applied pressure are Gas pressure sintering (GPS) typically at 0.001-0.02 GPa and 1200-1650° C., Hot pressing, Spark plasma sintering(SPS) typically at 10-50 MPa and 1200-1650° C., hot isostatic pressure (HIP) typically at 0.1-0.3 GPa and 1200-1650° C. and high pressure high temperature(HP/HT) typically at 1-6 GPa and 1200-1650° C.

The exact pressure and temperature for each process and application are determined by the person skilled in the art based on material composition and the specific process equipment that is used.

Graphitization is a step, commonly used when making SCD, where parts of the diamond are transformed into graphite, the graphite can then react with other components. In the method of making diamond composites according to the present invention the graphitization step is optional. Whether or not it takes place depends on a number of things, e.g. pressure, temperature, atmosphere, if the diamonds are coated, components in the feed etc.

In one embodiment of the present invention, no, or a minimum of graphitization takes place. By that is herein meant that less than 6 wt %, preferably less than 1 wt % of the diamonds are transformed into graphite.

In one embodiment of the present invention a graphitization step is included in the method. The graphitization is then performed either as a separate step or as a first step of the sintering. Graphitization suitably takes place in vacuum or a controlled atmosphere, suitably an inert gas, at a temperature of 700-1900° C., preferably 1000-1900° C.

Infiltration is a process well known in the art. A liquid alloy is infiltrated into the diamond composite body under high temperature. In the method of making diamond composites according to the present invention an infiltration step is optional.

In one embodiment of the present invention, no infiltration takes place.

In another embodiment of the present invention, an infiltration step is included in the method. Suitably, the infiltration is performed by any known method in the art, i.e. by melting of the corresponding alloy directly on the surface of the composite body, by dipping the body in the corresponding melt, by melting the alloy in contact with the body, or by pouring of the corresponding melt onto the surface of the body. Suitable alloys for the infiltration are Si, Al ,Si-rich alloys, or alloys thereof.

In one embodiment of the present invention both a graphitization step and an infiltration step is included where the formed graphite reacts with the infiltration alloy.

In one embodiment of the present invention a graphitization step but no infiltration step is included. The graphite that is formed will then react with other components during the sintering, such as metallic carbide formers.

In one embodiment of the present invention no graphitization step but an infiltration step is included. The infiltration alloy will then react with one or more of added carbides, carbonitrides, organic binder residues, diamonds or other carbon sources.

The diamond composite according to the present invention can be used as any cutting tool known in the art.

In one embodiment of the present invention the diamond composite is used for top hammer drilling (TH) and down the hole (DTH) drilling in e.g. granite, chromite, iron ore sandstone, pot ash, and salt.

In one embodiment of the present invention the diamond composite is used for mineral and ground tools (MGT) e.g. for mechanical cutting of rock in e.g. granite, chromite, iron ore, sandstone, pot ash, coal, gypsum, asphalt, concrete and salt.

In one embodiment of the present invention the diamond composite is used for oil and gas applications.

In one embodiment of the present invention the diamond composite is used for Rotary drilling, e.g. in for granite and metal ores.

In one embodiment of the present invention the diamond composite is used when machining metal in cutting operations such as drilling, milling and turning.

### EXAMPLE 1

Diamonds with a size of 10-15 micrometers in the amount of 70 wt % was mixed with 17 wt % TiC powder and 13 wt % Si powder, in deionized water to form a slurry. All amounts are given as weight percent of the dry powder weight. The water was removed from the slurry by pan drying. The powder was put in an Al₂O₃-cup and sintered in an Ar atmosphere at atmospheric pressure at approximately 1500° C.

The sintered compact was examined using x-ray diffraction (XRD) and scanning electron microscopy.

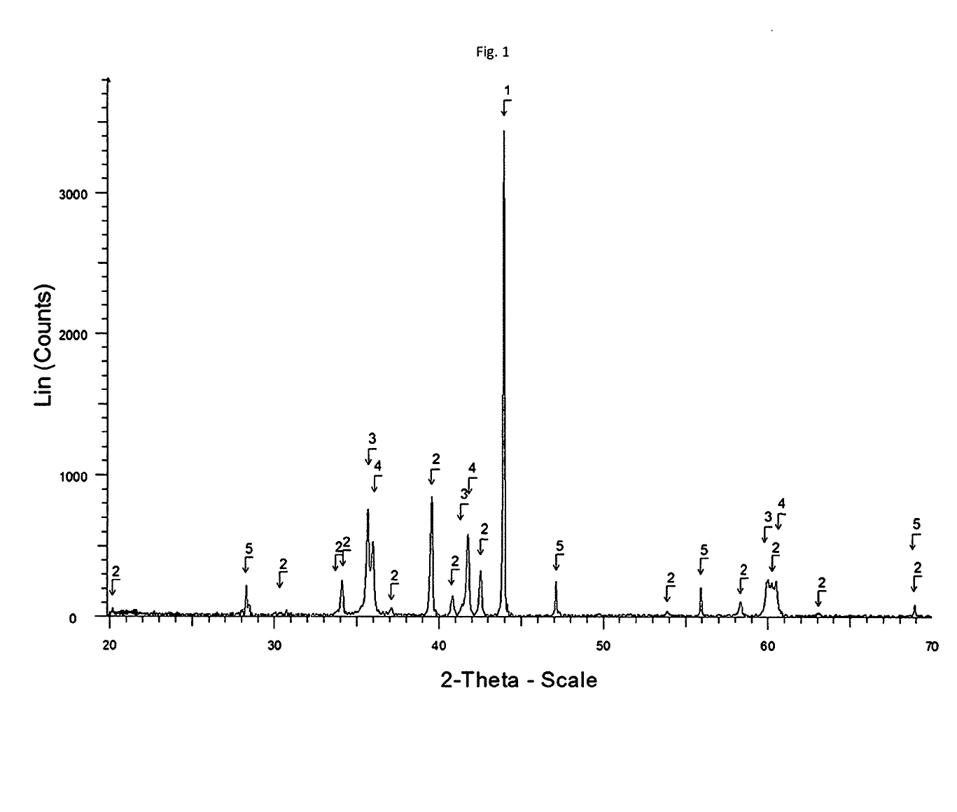

The XRD-diffractogram, FIG. 1, was obtained at room temperature using a XPERT-PRO diffractometer using CuKa-radiation. The background and the intensity from CuKα2-peaks were subtracted using DIFFRAC Plus Evaluation software. The diffractogram was also corrected for sample displacement using the 111-peak of Diamond (PDF No. 00-006-0675) as an internal standard.

The reflections in the diffractogram were indexed with numbers according to the following:
1. Diamond 111-reflection, Diamond PDF No. 00-006-0675.
2. MAX-phase Ti₃SiC₂, PDF No. 01-074-0310. The Ti₃SiC₂-structure has also been determined using neutron powder diffraction by Rawn et al in Mater. Sci. Forum (2000) 321/324, 889-892.
3. SiC, Moissanite-3C, PDF No. 00-029-1129.
4. TiC, Khamrabaevite, PDF No. 00-032-1383.
5. Si, Silicon, PDF No. 00-027-1402. The unit cell dimensions of the residual Si in this sample have been slightly shifted in 2 theta, probably due to doping.

Phase analysis with XRD showed the presence of diamond, SiC, and Ti₃SiC₂, see FIG. 1. By visual observation in SEM it was seen that a tendency for SiC to form between the diamond surfaces and the Ti₃SiC₂ phase.

### EXAMPLE 2

Diamonds coated with silicon carbide having an average grain size of 177-210 μm in the amount of 67 wt % was mixed with 3 wt % carbon black, 17 wt % TiC powder and 13 wt % Si powder, in deionized water to form a slurry. All amounts are given as weight percent of the dry powder weight. The water was removed from the slurry by pan drying. The powder was put in an Al₂O₃-cup and sintered in an Ar atmosphere at atmospheric pressure at approximately 1500° C.

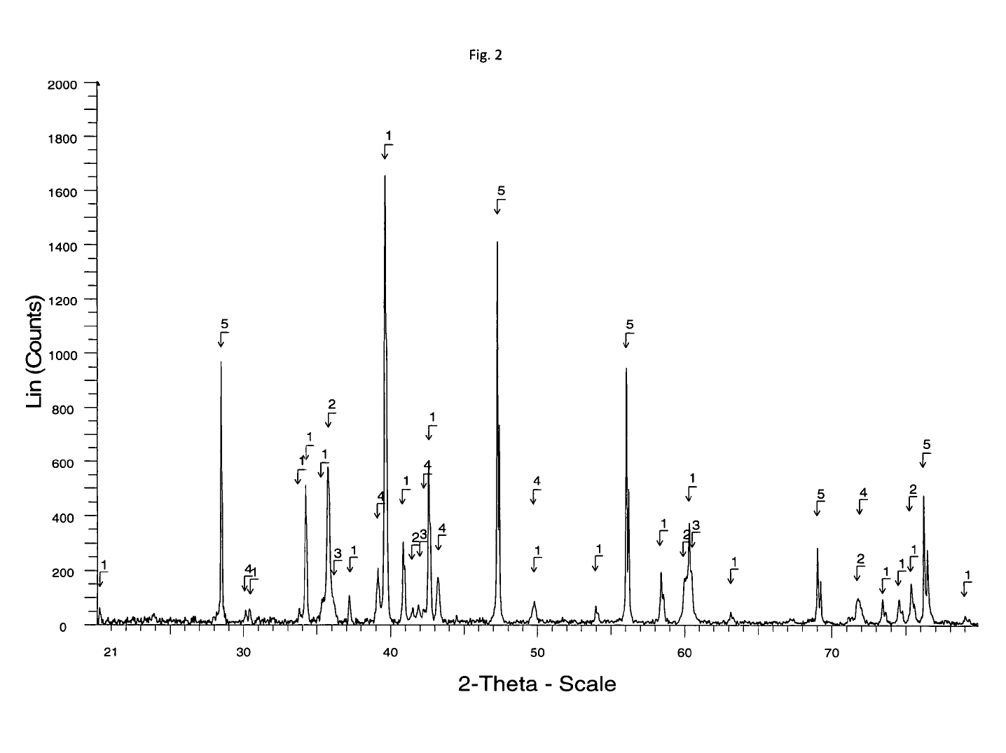

The sintered compact was examined using x-ray diffraction (XRD), FIG. 2.

The XRD measurement was done in the same equipment as FIG. 1. The background was subtracted using DIFFRAC Plus Evaluation software. The reflections in the diffractogram were indexed as;
1. MAX-phase Ti3SiC2 PDF No. 01-074-0310. The Ti₃SiC₂-structure has also been determined using neutron powder diffraction by Rawn et al in Mater. Sci. Forum (2000) 321/324, 889-892.
2. SiC, Moissanite-3C, PDF No. 00-029-1129.
3. TiC, Khamrabaevite, PDF No. 00-032-1383.
4. Alpha-Ti₂Si, PDF No. 00-035-0785 (*)
5. Si, Silicon, PDF No. 00-027-1402.

In the sample large single crystal SiC-coated diamonds around 200 microns were also present, but due to the orientation of the diamond crystals present in the powder XRD-sample no diffraction peaks of this phase could be detected.

Phase analysis with XRD showed the presence of, SiC, and Ti₃SiC₂, see FIG. 2. The XRD measurements did not show any graphite. By visual observation in SEM diamonds were clearly visible.

### EXAMPLE 3

A powder blend with diamond (85 wt %), TiC (9 wt %) and Si (6 wt %) powders were mixed with 20 vol % PEG (the PEG is not included in the powder dry weight) and water together. The mixture was freeze granulated and the granulated powder mixture was then pressed into discs that were subjected to an elevated temperature of 450° C. in hydrogen in order to remove the organic binder (PEG) and then to 1300° C. for in order to partially react the Si with diamond to form SiC and form a hard green part.

The Si powder had been jet-milled to a grain size <10 μm. The grain size of the TiC was 0.9 μm. A mix with two types of diamonds where used with the grain size fraction is: 80% 20-30 μm and 20% 4-8 μm

The discs were then subjected to an HPHT treatment at a temperature of 1350° C. and a pressure of 3 GPa for 10 minutes.

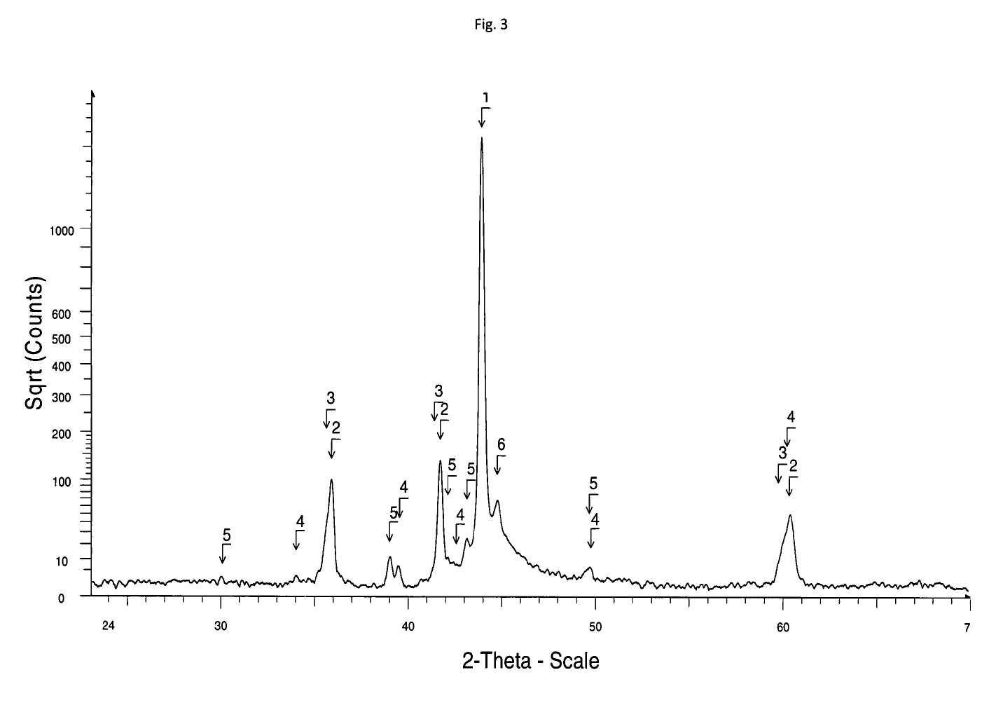

The sintered compact was examined using x-ray diffraction (XRD). Phase analysis with XRD showed the presence of diamond, SiC, and Ti₃SiC₂, see FIG. 3.

FIG. 3 shows an X-ray diffractogram of the composite according to Example 3 which have been measured at in the same equipment as FIG. 1. The background was subtracted using DIFFRAC Plus Evaluation software. The diffractogram was also corrected for sample displacement using the 111-peak of Diamond (PDF No. 00-006-0675) as an internal standard. The reflections in the diffractogram were indexed with numbers according to the following:
1. Diamond 111-reflection, Diamond PDF No. 00-006-0675.
2. TiC, Khamrabaevite, PDF No. 00-032-1383.
3. SiC, Moissanite-3C, PDF No. 00-029-1129
4. MAX-phase Ti₃SiC₂, PDF No. 01-074-0310. The Ti₃SiC₂-structure has also been determined using neutron powder diffraction by Rawn et al in Mater. Sci. Forum (2000) 321/324, 889-892.
5. Alpha-TiSi₂, PDF No. 00-035-0785.
6. Si₅C₃, PDF No. 01-077-1084. This phase is more correctly described as Si_{1.25}C_{0.75} and the structure determination by Khaenko et al. can be found in Inorg. Mater. (1995) 31, 304-309. No residual Si could be detected by XRD.

1. A diamond composite comprising diamond particles embedded in a binder matrix comprising SiC and a Mn+1AXn-phase, where n=1-3, M is one or more elements selected from the group Sc, Ti, Zr, Hf, V, Nb, Ta, Cr, and Mo, A is one or more elements selected from the group Al, Si, P, S, Ga, Ge, As, Cd, In, Sn, Tl, and Pb and X is carbon and/or nitrogen, wherein no diamond-to-diamond bonding is present.

2. A diamond composite according to claim 1, wherein the diamond particles constitute between 20 to 90 vol % of the total volume.

3. A diamond composite according to claim 1, wherein the amount of SiC in the binder is 1 to 55 vol % of the total volume.

4. A diamond composite according to claim 1, wherein the amount of Mn+1AXn-phase is 1 to 50 vol % of the total volume.

5. A diamond composite according to claim 1, wherein for the Mn+1AXn-phase, n=1 and A is Si and/or Al.

6. A diamond composite according to claim 1, wherein for the Mn+1AXn-phase, n=2, X is carbon and A is Si and/or Al.

7. A diamond composite according to claim 1, wherein for the Mn+1AXn-phase, n=3 and A is Si and/or Al.

8. A method of making a diamond composite comprising the steps of:
providing diamond particles embedded in a binder matrix comprising SiC and a Mn+1AXn-phase, where n=1-3, M is one or more elements selected from the group Sc, Ti, Zr, Hf, V, Nb, Ta, Cr, and Mo, A is one or more elements selected from the group Al, Si, P, S, Ga, Ge, As, Cd, In, Sn, Tl, and Pb and X is carbon and/or nitrogen , wherein no diamond-to-diamond bonding is present;
mixing the diamond particles and powders comprising the Mn+1AXn-phase and/or the one or more element M and the one or more element A either as pure metals or as carbides, nitrides, carbonitrides or oxycarbonitrides, in a mixing liquid to form a slurry; and
drying said slurry into a powder which is then formed into a body of desired shape, which is subjected to infiltration of a Si source during a sintering operation.

9. A method of making a diamond composite comprising the steps of:
providing diamond particles embedded in a binder matrix comprising SiC and a Mn+1AXn-phase, where n=1-3, M is one or more elements selected from the group Sc, Ti, Zr, Hf, V, Nb, Ta, Cr, and Mo, A is one or more elements selected from the group Al, Si, P, S, Ga, Ge, As, Cd, In, Sn, Tl, and Pb and X is carbon and/or nitrogen , wherein no diamond-to-diamond bonding is present;
mixing the diamond particles, a Si source, and powders comprising the Mn+1AXn-phase and/or the one or more element M and the one or more element A either as pure metals or as carbides, nitrides, carbonitrides or oxycarbonitrides, in a mixing liquid to form a slurry,
drying said slurry into a powder which is then subjected to a sintering operation.

10. A method of making a diamond composite according to claim 9, further comprising the step of adding a pressing agent to the slurry, wherein the body is formed in a pressing operation before the sintering operation.

11. A method of making a diamond composite according to claim 9, further comprising the steps of graphitization and infiltration.

12. A method of making a diamond composite according to claim 9, wherein no, or a minimum of, graphitization occurs.

13. A method of making a diamond composite according to claim 9, wherein no infiltration occurs.

14. A method of making a diamond composite according to claim 9, wherein the pressing and sintering is done sequentially in one operation.

15. A method of making a diamond composite according to claim 9, wherein the diamond particles are coated.

16. A method of making a diamond composite according to claim 8, further comprising the step of adding a pressing agent to the slurry, wherein the body is formed in a pressing operation before the sintering operation.

17. A method of making a diamond composite according to claim 8, further comprising the steps of graphitization and infiltration.

18. A method of making a diamond composite according to claim 8, wherein no infiltration and no, or a minimum of, graphitization occurs.

19. A method of making a diamond composite according to claim 8, wherein the pressing and sintering is done sequentially in one operation.

20. A method of making a diamond composite according to claim 8, wherein the diamond particles are coated.
